(19) United States
(12) Patent Application Publication
(10) Pub. No.: US 2010/0257000 A1
(43) Pub. Date: Oct. 7, 2010

(54) ENGINE, SYSTEM AND METHOD FOR UPSELLING PERISHABLE PRODUCTS OR SERVICE ITEMS

(76) Inventor: Ken Harris, Montreal (CA)

Correspondence Address: DRINKER BIDDLE & REATH;ATTN: INTELLECTUAL PROPERTY GROUP, ONE LOGAN SQUARE, SUITE 2000, PHILADELPHIA, PA, 19103-6996, US

(21) Appl. No.: 12/648,662

(22) Filed: Dec. 29, 2009

Related U.S. Application Data
(60) Provisional application No. 61/166,719, filed on Apr. 4, 2009.

(51) Int. Cl. G06Q 30/00; G06Q 50/00; G06Q 10/00

(52) U.S. Cl. 705/5; 705/10; 705/14.33; 705/26

(57) ABSTRACT

A software engine, system and method for increasing sales revenue of ones selected from a set of perishable items supplied by a service provider is described. The engine, system and method follows a rules set that includes information relating to a total number of perishable items available for sale in the set, and to a price of at least the available ones of the set, for bidding of a unique dollar value by at least two users, such as by auction bidding. The engine, system and method arrives at a list of winning bids and reports the list to the service provider.

### CROSS-REFERENCE TO RELATED APPLICATIONS

This application claims the benefit of priority to U.S. Patent Application No. 61/166,719, filed on Apr. 4, 2009, the entire disclosure of which is incorporated by reference herein as if set for herein in its entirety.

### FIELD OF THE INVENTION

The instant invention relates to a system and method of increasing revenue streams for providers of perishable products and/or services, and more particularly to an engine that allows such providers to successfully monetize available upgrades and openings of perishable products and/or services to existing customers.

### BACKGROUND OF THE INVENTION

The financial success of companies providing perishable products or services, such as commercial airlines, railways, entertainment tickets, automobile or lodging rental, and the like, is determined by their ability to maximize their revenues across available inventory prior to that inventory perishing. For example, in the airline industry, a particular scheduled flight will have a set cost to provide the flight, and there are a set number of available seats to sell to customers to potentially generate a profit.

One of the ways in which these companies try to maximize revenue is to offer items of varying quality at varying prices, based on the concept that the sum total of seats sold at the various prices will be greater than the sum total of seats sold at a fixed price, and/or that the sale of the same numbers of seats at varying prices will provide increased revenue over offering all seats at the same price. Using again the example of the airline industry, a scheduled flight may utilize an airplane that has seating tiered into increasing levels of quality, such as “economy class” seating, “business class”, and/or “first class”.

While this model of varying the quality and cost of perishable items has been generally successful, it is far from optimized. Again, in the case of a scheduled flight, it is often the case that “first class” seating goes unused, or that such seating is simply offered to a frequent or preferred customer without the generation of additional revenue for that particular flight. Further, there are instances when certain customers will not select a particular flight if seating in their preferred “class” is not available.

In recent years, numerous third party merchants have created online internet platforms to help increase the number of sales for these perishable items. Business models for such platforms include special discounts, “name your own price”, including suggested ranges of offerings for upgrades, and cross-selling different but related perishable products that may be desirous to the customer. However, in addition to being limited to only specific pricing and/or bidding models, these platforms are also limited to undesirable time restraints or enrollment periods, or unknown item availability, which inhibit the maximization of revenue for the sale of the total perishable items for a given event or service. Further, these prior systems are typically constrained to particular types of items, such as only for travel related items and not for concerts or sporting events, and visa versa.

What is needed is an engine, system and method for controlling variable and customizable pricing and bidding options to maximize revenues, wherein the pricing is dynamic and presents sufficient flexibility to induce the customer to pay to upgrade where he might not otherwise.

### SUMMARY OF THE INVENTION

A software engine, system and method is disclosed for increasing sales revenue of ones selected from a set of perishable items supplied by at least one service provider. The engine, system and method includes at least one computing memory associated with a plurality of rules, wherein the plurality of rules include a first information item relating to a total number of perishable items available for sale in the set, and a second information item relating to a price of at least the available ones of the set, wherein the plurality of rules provide for bidding of a unique dollar value, by at least two users on ones of the available ones, from a networked computing device locally associated with the plurality of rules and wherein at least the price and the total number constrain acceptable ones of the bids. The bids are preferably auction bids. The engine, system and method further include at least one networked computer processor that receives the at least two bids and applies ones of the plurality of rules drawn from the at least one computing memory to arrive at a list of winning bids from the acceptable ones for recommendation to the at least one service provider, and at least one computing port that reports, in accordance with at least one of the plurality of rules, to the at least one service provider the list.

In one embodiment, the at least one perishable item is an upgrade of an item from the set previously reserved by the user. In another embodiment, the bidding comprises a closed auction. In another embodiment, the bidding comprises a timeframe that begins when at least one of the perishable items supplied by the service provider becomes an available one. In another embodiment, the first information item is updatable in real time. In another embodiment, the second information item is at least a suggested price. In another embodiment, the suggested price is a minimum price. In another embodiment, the at least one suggested price is a preselected percent value of less than 100% of an original retail price. In another embodiment, the at least one suggested price is a preselected price range that is less than an original retail price. In another embodiment, the at least one placed bid at least partially contains a charitable donation. In another embodiment, the at least one placed bid at least partially contains a non-monetary component. In another embodiment, the non-monetary component corresponds to a specific action performed by the bidding user. In another embodiment, the non-monetary component is at least one rewards program point. In another embodiment, the plurality of rules further comprises at least one information item selected from the group consisting of length of travel, traditional purchasing patterns of users, current load factor, demand for a lower-tiered item, and a loyalty program status of the user. In another embodiment, the list of winning bids is ranked. In another embodiment, the list is ranked according to a priority rules set. In another embodiment, the perishable item set is at least one selected from the group consisting of airline tickets, train tickets, bus tickets, automobile rentals, cruise tickets, hotel room reservations, house reservations, concert tickets, sporting event tickets, shipping reservations and conference reservations.

Also described is a method of increasing sales revenue of a perishable item set supplied by at least one service provider. The method includes the steps of sending an invitation to at least one user to bid on at least one available perishable item from the perishable item set, the invitation generating from a networked computer processor and transmitted via a communications network to a networked computing device operated by the at least one user, applying a plurality of rules resident on at least one computing memory associated with the networked computer processor, wherein at least ones of the plurality of rules comprise a first information item relating to a possible number of perishable items available for sale in the perishable item set, and a second information item relating to a price of each of the perishable items available for sale, wherein the plurality of rules constitute a bidding mechanism for the user to place at least one bid on at least one of the available perishable items. The method further includes receiving at least one bid on the at least one available perishable item from the networked computing device operated by the user, generating a recommended list of winning bids for ones of the available perishable items, and transmitting to the at least one service provider a report corresponding to the recommended list of winning bids.

Thus, the present invention provides an engine, system and method for controlling variable and customizable pricing and bidding options to maximize revenues, wherein the pricing is dynamic and presents sufficient flexibility to induce the customer to pay to upgrade where he might not otherwise.

### BRIEF DESCRIPTION OF THE FIGURES

Understanding of the present invention will be facilitated by consideration of the following detailed description of the embodiments of the present invention taken in conjunction with the accompanying drawings, in which like numerals refer to like parts and in which:

FIG. 1 illustrates an exemplary system architecture, according to an aspect of the present invention;

FIG. 2, comprising FIGS. 2A-2C, illustrate comparative charts of an existing revenue generating platform with an exemplary revenue maximization platform according to an aspect of the present invention.

FIG. 3 illustrates a flowchart of an exemplary method of increasing revenue from the sale of perishable items, according to an aspect of the present invention;

FIG. 4 illustrates an exemplary low tier upgrade prompt process, according to an aspect of the present invention;

FIG. 5 is a flowchart of an exemplary “late hour” process, according to an aspect of the present invention;

FIG. 6 illustrates an exemplary reservation request process; and

FIG. 7 illustrates an exemplary late hour process.

### DETAILED DESCRIPTION OF THE INVENTION

It is to be understood that the figures and descriptions of the present invention have been simplified to illustrate elements that are relevant for a clear understanding of the present invention, while eliminating, for the purpose of clarity, many other elements found in typical product and/or service enhancement and/or bidding systems. Those of ordinary skill in the art will recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art. Furthermore, the embodiments identified and illustrated herein are for exemplary purposes only, and are not meant to be exclusive or limited in their description of the present invention.

As contemplated herein, the present invention includes a system and method of increasing or maximizing revenue of perishable products and/or services, described generally hereinthroughout as “perishable items” or “items”. Without limitation, such items may include tickets (physical or electronic) for events, travel, lodging, and/or reservations for such items. Particular event examples may include air travel, rail travel, hotel lodging, house and car rentals, cruise lines, sporting events, concerts, broadway shows, shipping, business conferences and exhibitions, and the like. It should be appreciated that any item that includes a time sensitive component (making the item perishable) may be suitable for purchase, upgrade or upsell via the present invention. The system provides a novel rules-based and networked computer platform that allows providers of perishable items or third party merchants associated with such providers to offer item purchase, upgrade and/or upsell to consumers based upon a variety of pricing and bidding models.

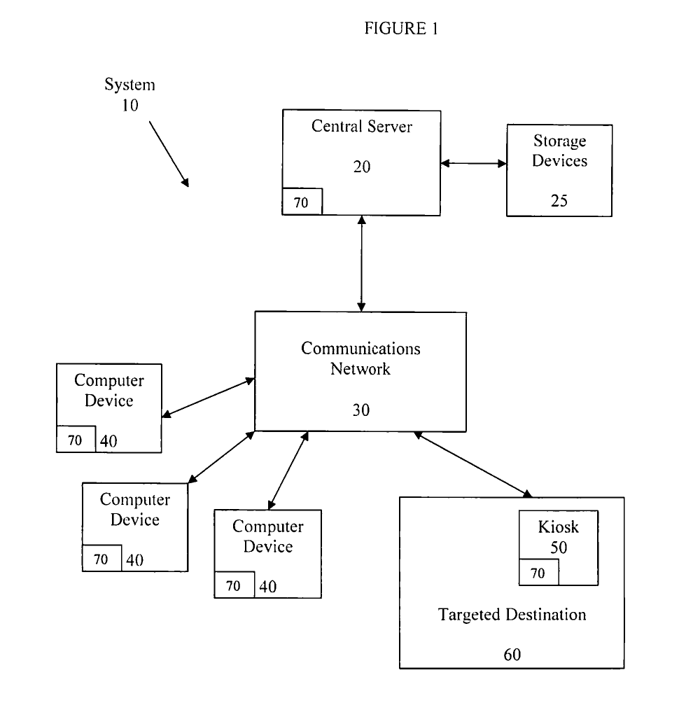

For example, as shown in FIG. 1, system 10 may include a central server 20 that is connected by a communications network 30 to a prospective user's (or customer's) computer device 40. Central server 20 may be comprised of one or more computers and include or otherwise be connected to one or more mass storage devices 25. It should be appreciated that central server 20 and associated storage devices 25 may each be scalable as desired for system 10, and will include all those hardware and programming components necessary for use within system 10. System 10 may further include a system administrator (not shown) for managing and synchronizing central server 20 functionality. Consumer devices 40, as mentioned above, may include, without limitation, desktop and laptop computers, netbooks, handheld computing devices, such as PDAs or phones, kiosks 50, or any other computing device, provided such devices are capable of connecting to communications network 30. Communications network 30 may include any and all forms of telecommunications as understood by those skilled in the art, including all internet based data exchange. Examples of such communications may include voice calls, instant messaging, email, standard and streaming data exchange, text messaging, or any other type of communication suitable over a telecommunications network. Communications network 30 may further include an open, wide area network (e.g., the internet), an electronic network, an optical network, a wireless network, a physically secure network or virtual private network, and any combinations thereof. Communications network 30 may also include any intermediate nodes, such as gateways, routers, bridges, internet service provider networks, public-switched telephone networks, proxy servers, firewalls, and the like, such that communications network 30 may be suitable for the transmission of data throughout system 10. System 10 may utilize any conventional operating platform or combination of platforms, and may utilize any conventional networking and communications software as needed. Data messages and data upload or download may be delivered over communications network 30 using typical protocols understood by those skilled in the art, including, without limitation, TCP/IP, HTTP, SMTP, RPC, FTP or the like.

In a specific alternative embodiment, system 10 may further include stationary networked kiosks 50, which may be positioned at targeted destinations 60 associated with the event for which the perishable item applies. For example, a kiosk may be positioned at or near an airport or train station ticketing desk, in a hotel lobby, near the will-call window of a sporting complex or theatre, or at any other logical location for a consumer to obtain a perishable item or perform a transaction relating to the perishable item.

Individual user accounts may be established to manage, track and to customize information for, or to target information or promotional material to, particular users or sets of users. System 10 may also include a registration system, such that, if the user has previously visited system 10 and entered and set up a user account, meaning particular information, such as an identifier, has been saved in the system, system 10 may acknowledge this fact, and simply apply information provided by the user in the previous registration. Once a user is registered in the system, that user's activity may be tracked and/or monitored, to better understand user behavior, and to potentially serve as priority information related to bid ranking and tie-breaker mechanisms as described hereinbelow. Individual email accounts may also be established, or previously existing email accounts may be associated with individual user accounts to allow system 10, or other organizations participating in system 10, to send email messages to any particular user or group of users.

An encryption standard may also be used to protect files from unauthorized interception over communications network 30. Any encryption standard or authentication method as may be understood by those having ordinary skill in the art may be used at any point in system 10. For example, encryption may be accomplished by central server 20 encrypting an output file by using a Secure Socket Layer (SSL) with dual key encryption. Additionally, system 10 may limit data manipulation, or information access. For example, a system 10 administrator may allow for administration at one or more levels, such as at an individual user level, or at a system level. The system 10 administrator may also implement access or use restrictions for users at any level. Such restrictions may include, for example, the assignment of user names and passwords that allow the use of the present invention, or the selection of one or more data types that a user is allowed to view or manipulate.

System 10 further includes software architecture 70, which may be managed by central server 20. Software architecture 70 may include a software framework that optimizes ease of use of at least one existing software platform, and that may also extend the capabilities of at least one existing software platform. Software architecture 70 may approximate the actual way users organize and manage data, and thus may organize use activities, such as pricing and bids, in a natural, coherent manner while delivering such use activities through a simple, consistent, and intuitive interface within each application and across applications. Software architecture 70 may also be reusable, providing plug-in capability to any number of additional applications, without extensive re-programming, which may enable parties outside of system 10 to create components that plug into the system 10 platform. Thus, software or portals may be extensible and new software or portals may be created for the architecture by any party.

Software architecture 70 may provide, for example, applications accessible to one or more users to perform one or more functions. Such applications may be available at the same location as the user, or at a location remote from the user. Each application may provide a graphical user interface (GUI) for ease of interaction by the user with information resident in system 10. A GUI may be specific to a user, set of users, or type of user, or may be the same for all users or a selected subset of users. Software architecture 70 may also provide a master GUI set that allows a user to select or interact with GUIs of one or more other applications, or that allows a user to simultaneously access a variety of information otherwise available through any portion of system 10.

Software architecture 70 may also be a portal that provides, via the GUI, remote access to and from system 10. Software architecture 70 may include, for example, a network browser. Software architecture 70 may include the ability, either automatically based upon a user request in another application, or by a user request, to search or otherwise retrieve particular data from central server 20 or other remote points, such as standard information access via the internet. Software architecture 70 may vary by user type, or may be available to only a certain user types, depending on the needs of system 10. Users may have some portions, or all of software architecture 70, resident on computer devices 40 (originally provided to the device by download) or programmed kiosks 50, or may simply have linking mechanisms, as understood by those skilled in the art, to link computer devices 40 or kiosks 50 to software architecture 70 running on central server 20 via communications network 30.

Presentation of data through software architecture 70 may be in any sort and number of selectable formats. For example, a multi-layer format may be used, wherein additional information is available by viewing successively lower layers of presented information. Such layers may be made available by the use of drop down menus, tabbed pseudo-manila folder files, or other layering techniques understood by those skilled in the art. Formats may also include AutoFill functionality, wherein data may be filled responsively to the entry of partial data in a particular field by the user. All formats may be in standard readable formats, such as XML, or any other formatting as understood by those skilled in the art. Software architecture 70 may also support any sort of interactive purchasing platform, where a user may receive advertisements and purchase items from system 10 or from any third party connected to system 10 via communications network 30, as described hereinthroughout. Software architecture 70 may further include a control panel, operated by a system administrator or other managing personnel through a similar GUI. It should be appreciated that such a control panel may allow the provider of system 10 (or “system provider”) the ability to access all data and activate and/or manipulate any rules sets as described hereinbelow, including any override functionality. Thus, system 10 may function as a revenue management and resource allocation tool, for the service provider.

System 10 may perform all processes as described herein and subsequently communicate resulting data, or any portion thereof, with the perishable item and/or event provider, and/or with a provider of the services described herein, collectively referred to generally herein as the “service provider”, in order to conduct or confirm transactions with the customers using system 10. System 10 may be operated by the service provider itself, or integrated into existing platforms owned or otherwise managed by the service provider. Any party operating or managing system 10 may be referred to herein as the “system provider”. In further embodiments, the system of the present invention may also be licensed or exclusively licensed to a single service provider of a particular industry, such as allowing only Marriott to use the system for hotel bookings, or the system may be non-exclusively licensed, such that multiple service providers in an industry may compete with each other via use of the present invention.

For example, as a stand-alone service, system 10 may receive, from a service provider, data that is representative of the perishable items and all other data indicative of information necessary to sell, upgrade or upsell available ones of such perishable items. Such information may include, by non-limiting example, one or more of total items, such as an inventory, available for all available item categories, desired price of all items, suggested bid for items, acceptable lowest bid for items, paid price for any items already sold, expiration times for any particular item, historical pricing and sales data, individual customer account data and activity (historical usage of systems, including bid successful and failure), and the like.

In one embodiment wherein the service provider is an airline, the data may be indicative of available seating arrangements and seating classes, for a given flight. Where a consumer has already purchased a seat for the flight, the data is further indicative of the occupied seat, the identity of the occupier of the seat, the available seats in a higher quality seating class and their respective relative prices, and/or the prices paid by other higher quality occupied seats.

In another example, the service provider may operate system 10. This may allow the service provider to reference its own customer database or customer sales database, and utilize any such data stored therein. It should be appreciated that system 10 may seamlessly coordinate perishable item sales across multiple service providers at the same time or within the same setting, such that customers can use system 10 to purchase and/or upgrade multiple item times from a single platform. For example, from system 10, a business traveler may upgrade his/her flight and hotel, while initiating an original purchase on a car rental and a seat at a local sporting event at the location to which he/she is traveling to.

Similarly, the system of the present invention may be jointly provided. For example, a service provider may provide an initial reservation, and may, responsive to the rules discussed hereinbelow, be the final approval mechanism for an upgrade to the initial reservation responsive to, for example, a customer bid. In such an embodiment, the service provider may provide the good news to a customer that an upgrade is being provided responsive to a bid, wherein the recommendation to provide the upgrade results from application of the system of the present invention. However, if the rules dictate that no upgrade will be provided, that news may be delivered by the present invention, without consultation to the service provider, thereby shielding the service provider from delivering bad news.

Likewise, the present invention may provide the upsell to an upgrade prior to execution of the initial reservation. For example, the customer may use a service provider GUI to make an initial reservation, and/or may use the GUI provided by the present invention as discussed hereinbelow. In such an embodiment, once the initial reservation has been selected by the customer, but before it has been paid for, the customer may be given the option to leave the initial reservation (which may or may not have been selected using the bid process discussed hereinthroughout), and, using the GUI of the present invention, bid on an upgrade. If the upgrade is granted, the customer may be returned to finalize the initial reservation, and pay for the upsold upgrade as part of that transaction. Similar exemplary embodiments will be apparent to those skilled in the art in light of the discussion hereinthroughout.

More specifically, the present invention may offer multiple options, wherein customers can book, or upgrade, one or more perishable items. Such booking may be tracked and identified differently than in the prior art. For example, the bookings in the present invention may be customer-centric, rather than itinerary-centric. Thereby, each customer's bid, level of satisfaction, and associated information may be uniquely available in the present invention, rather than solely an itinerary being available, which itinerary may have associated therewith multiple customers, or only one type of booking (i.e. flight information), rather than many bookings related to each unique customer. Multi-faceted information for each customer allows for the use of record identifiers.

Record identifiers may allow for tracking of bids for various items, and/or use of items, using either or both of information from the present invention and information from each service provider. Thereby, the use of record identifiers in a customer-centric system allows for intercommunication of information not previously available in the prior art. For example, a customer may book with Airline A. The customer may then, using the present invention, bid and win an upgrade on Airline A. The customer's status level on Airline A is communicated either from Airline A to the present invention, and/or from the present invention to Airline A, such as by a well understood communicative “ping” from or to the reservation and data system of Airline A. Likewise, using information obtained from Airline A regarding status, the present invention may obtain bonus points for Airline A customers of that status offered by Hotel B, also obtained through the present invention, and may use that status to boost that customer's bid for an upgrade on Rental Car C, wherein Rental Car C accepts points from Airline A status customers, and wherein the Rental Car C bid is placed using the present invention.

As contemplated herein, the system may include a variety of pricing and/or bidding mechanisms to maximize revenue on the sale of perishable items. This system is based on the premise that there is no significant cost in filling an otherwise empty seat for an event, and therefore, any mechanism that collects additional fees for empty, higher priced seats will aid in maximizing revenue for that event. This model also may open up lower cost seats for last minute purchase, which will undoubtedly have a greater percent chance of selling than the higher priced seats, and such opening of lower price seats may, in some embodiments, be corresponded to the upgrades granted to prior holders of the lower priced seat. In all, the provider of the present invention may generate revenue by collecting a flat fee from the service (or event) provider, or it may receive a commission from the service provider based on how much additional fees it collects for upselling or upgrading customers. In certain embodiments, the system platform may be labeled separately from the service provider so as to allow for distinguished service and accountability, and/or to allow for offering by the service provider as a bonus service, or add-on, while, in other embodiments, the system may be co-labeled or exclusively labeled by the service provider so as to allow for readily apparent ownership of the system. Yet, further, channel partners, that is, services associated with the purchase of perishable items, but which are not service providers of perishable items, such as credit card companies, travel agents, auctioneers, and the like, may be associated with, or offerors of, the services of the present invention as discussed herein. Because the system of the present invention is designed to profit by upgrading items for existing customers, the system provider may additionally optionally function as a “no booking fee” service for these and other embodiments, for which savings, agency fees, commissions, or the like may be credited or returned to the service provider, to the customer, or a combination of the two.

The pricing and/or bidding mechanisms may be performed by the system via a rules-based engine forming part of the system software architecture described previously. As used herein, a rules-based engine may include a software engine or program having resident therein a plurality of rules, wherein, upon access to information to which such rules may be applied, the rules may be updated, modified, or varied as to which next set of those rules is applied. A rules-based engine may include, for example, computer models, algorithms, comparisons, calculations, pattern recognition, data accumulation, language processing, comparative problem solving, and the like, to predict and calculate optimal revenue generation.

According to an aspect of the present invention, a customer bid data structure may be used to determine winning bids for a particular perishable item. For example, bid data may be distributed in different tables and cross referenced. Alternatively, a bid table may be constructed. In an exemplary embodiment, customer bid data (indicative of a reservation record in the form of an itinerary-centric record, as in the prior art, or a customer-centric record, as discussed herein) may have a bid entry in the table, with a reference to the event. Alternatively, the event may have a table for the bids, with pointers or tags associated with the bidding customers. It should be appreciated that relational database architectures may be used to create multiple tables that can be related together using appropriate relational database query commands, such as JOIN, as would be understood by those skilled in the art. Interrelated data items that make up a particular customer's bid and any customer data relevant to evaluating the bid may form at least part of a customer bid data structure. The system can also access customer bids and modify customer reservation data records or event data records as the process executes in real-time. This customer bid data structure may be supplemented with additional information, either by adding into the data structure or having the bid data structure reference the data. Further, a pending set of customer bids may itself form at least part of a data structure that further references data that is relevant to evaluating queued bids.

In an effort to retain control of the potential incremental revenue stream, the system may implement a variety of pricing functions to offer a limited set of choices for the consumer to choose from. General criteria that may be used to formulate rules that determine winning sale and/or upgrade bids may include, for example, setting a minimum bid, length of travel, traditional purchasing patterns of customers, current load factor, straight auction rules, demand for the lower-tiered items, previous bids or success rate of the customer, loyalty program status of a customer and service status of a customer, and the like. As used herein, “service status” may refer to what the expected quality of customer experience for the customer has been. In one embodiment, the customer database may be cross referenced with performance data. If a customer submitting an upgrade bid has received poorer performance, for example, that customer having been bumped off of one or more flights, or if one or more flights the customer has been booked on have been delayed for long periods of time, or if that customer's bids have been frequently or always reasonable but declined, this data can be utilized to provide a weighting preference for that customer and/or those bids in the rules set. In this way, the upgrade process may act to counterbalance other negative customer experiences associated with the service provider or the service. The criteria can also be combined into multiple rules, or rules that have many criteria that are applied.

Rules for determination of maximized revenue may be constructed in additional ways. For example, rules may be based on an auction style format, where an item is open for bidding within a select time period. The time period may be set, such as a definitive start time and stop time, or it may be open-ended, such as the start time being open from the creation of the item, or from a set period from the time the item perishes, such as 3 months, 1 month, 2 weeks, 2 days or even minutes from when the related event occurs and the item perishes. Of course, it should be appreciated that any period of time may be designated for the start time and stop time of a bidding auction. In certain embodiments, stop times may be set far away from the event date, so that consumers that do not win a bid for the item have a chance to get back into another bidding round, or otherwise purchase the item by another method. In another embodiment, the process may be ended earlier if sufficient incremental revenue has been generated. In another embodiment, the process may be arbitrarily ended upon the command of authorized provider personnel, or a system administrator.

The system may provide real time status of each bid, such that a consumer may see whether his bid is currently a winning bid, or whether it is no longer in contention. Bids may be updated, as in a standard auction format, to move back into contention to win. In certain embodiments, the system may provide messaging to consumers, such as text messages or email, to notify them if or when their bid falls out of contention. In another embodiment, the bid price(s) may be private, or hidden, or they may be public (although still anonymous), so that customers may competitively bid or re-bid on an item. Final prices for comparative items may also be shown or suggested to the customer, such that those customers may gauge the real-time market for the desired perishable item on which they are bidding.

For example, rules may be based on a pre-determined percentage of the desired item's price. In one embodiment, a front row ticket to a concert may have a desired cost of $300. An option set of various prices, such as $150 (or 50%), $225 (or 75%), or $270 (or 90%) may then be presented to the consumer to select from. In the event of there being a “tie” (such as 3 front row seats available and 4+ bids are submitted at the highest value), the tie-breaker may be determined by a tie-breaker rule, such as the consumer(s) who bid first (logged by timestamp), the consumer(s) who historically use the service provider more, the consumers having the most highest preferred status, or a secondary bid may be performed amongst the tied consumers, to either raise the price further, spend preferred points to win the tie, or any other tie-breaking mechanism as would be understood by those skilled in the art.

In another example, rules may incorporate a bucket interval mechanism. In this embodiment, a consumer may desire an upgraded class item, and may thus select pricing options from bucketed intervals or price ranges. For example, a consumer may be willing to pay between $50-$100, $101-200, or $201-$300 for an item. When the consumer(s) select bucket intervals, the consumers may be chosen based on the buckets they've selected against the number of items available. Based on the number of items available, the system may select from the buckets those consumers who will win the bids for the items. Of course, tie-breaking measures may also be employed, if necessary, and further bidding rounds may be utilized to narrow bucket ranges as needed.

In another example, rules may incorporate standard and/or custom algorithms. In this embodiment, the system may build mathematical functions linked to various event information, such as distance traveled, original cost, event length, or other related information as described previously. For example, the full upgrade price may be discounted by a value that is a function of the distance traveled by the customer. This function may also be dependent on the total distance traveled by all of the customers bidding on the upgrade item for the same event.

In another example, rules may incorporate a crowd-sourcing mechanism. In this embodiment, a price set may be determined as a function of “crowd-sourcing”, and presented to the customer bidding for an upgrade item. This would include a selected populous, such as existing or registered consumers, non-registered consumers, an online community, or the general public, to voice their proposed price as an open forum. This sort of mass-collaboration may provide pricing sets for selection in almost a “game like” fashion.

According to another aspect of the present invention, consumers may make charitable donations via the system of the present invention. For example, by making a donation to a charity, consumers may become eligible for upgraded service. This model may be used as part of a tie-breaking measure, or it may form part of a bidding and pricing mechanism. For instance, the customer may bid for an upgrade by specifying how much he is willing to donate to a particular charity, which may be a straight auction or selectable from a set. In this scenario, the highest donations may be deemed the winning bids. Charitable contributions may be handled directly by the system or by the customers, in which case such donations would need to be verified.

According to another aspect of the present invention, consumers may perform specific actions to become eligible to win a bid, or as functions of a bidding process. For example, the system may identify a set of measurable and comparable specific actions, such as the reduction of a carbon footprint or a recycling quota, to be performed and verified by consumers as all or part of a bid for an upgraded item.

According to another aspect of the present invention, a reward points program may be used to bid on items. The system of the present invention may utilize its own reward points program, or programs managed by the item providers or other third parties, or any combination of reward points programs. Alternatively, reward points may form only part of a bidding process, such as for tie-breakers, or for secondary bidding rounds. It should be appreciated that any sort of non-monetary payment and bidding mechanism may be used, such as with points, fictitious currency, or any other quantifiable unit of measure suitable for tracking, submitting and ranking customer bids. It should also be appreciated that coupons may be used to form part of any pricing, bidding and tie-breaking mechanism described herein. Such use of coupons may include unique codes to identify the coupon for entry into the system by the customer, to gain the benefit of the coupon. Coupons may be physical or electronic, and may be issued by the system provider, a service provider, or any other third party having a business relationship with the system provider, for example.

According to another aspect of the present invention, randomly generated price points may be generated by the system according to rules-based parameters. For example, when the system selects a pricing function, the system may also select a range and set of values. In one embodiment, the system may select the percentage discounts that are available. In yet another embodiment, the system may arbitrarily set the number of upgrades that are possible for a given price. In this way, a few early requesting consumers may get a cheaper upgrade item than those bidding later or vice versa. In another embodiment, the system may determine that there are more available upgrade items than upgrade requests to meet the rule, which may result in a weighting change. In this situation, particularly wherein there is resistance to higher prices, the system may open up or lower some item price points to additional consumers.

As contemplated herein, the system may be used both by customers who already hold a purchased item and would like to upgrade to another item, and by customers who have not yet purchased an initial item. Because the system receives consumer bids for both initial items and upgrade items, the system may function to upgrade or upsell both bidding groups. It should be appreciated that because the system may function in real-time, information relating to available class items may change for each group, and therefore the system may update or refresh in real time so that, as consumers are purchasing new and/or different items, newly available items or sudden unavailable items are recognized by the system and bid processes are altered to reflect and maximize such item movement. For example, when the system reserves the upgraded item, it also updates the additional lower level item from not available to available. In other words, the lower grade item is returned to available inventory for sale.

For customers who submit a winning bid for an item, a new ticket representative of the item may be issued, and a payment, such as a credit card or PayPal charge, or other transaction, is executed. Estimated payments may also be collected or reserved in advance. In certain embodiments, the customer may not be bound to purchase the upgrade item until the expiration of a predetermined time after the bidding results are final. However, if the customer fails to pay within the pre-determined time, the offer to upgrade may automatically go to the next best bidding customer, or the item may simply go back into the available item pool for re-bidding.

According to another aspect of the present invention, the system may provide a dynamic environment for service vendors to not only pre-set pricing and bidding criterion, but may also manipulate or otherwise change such criterion at any point in time via a control panel or input field. As such, included in or associated with the GUI discussed above may be a vendor control panel. The control panel may allow for inventory tracking, revenue increase information, rules management, bid management, report request, overrides of typical rules, parameter cascades, and the like. Further, monitoring of the control panel may provide data intelligence, such as regarding the customer satisfaction indicated by repeat bidders, or high bids repeated from the same bidder indicating that certain customers regularly fly certain legs and would be willing to pay an increased fare.

For example, in an exemplary embodiment where the system is managed a service provider, the system may query its database to retrieve the ranked list of available match upgrades for items, based on consumer submitted bids. The match upgrades that are sent to the service provider may be ranked based upon the provider's original rule settings. These criteria rules settings may be inclusive and may also be cascading, weighted, or combined, as explained previously, in terms of influence on the final ranked listing. Any or all criteria may alternatively be set on each individual item, or as a global rule set for a set of different but related items, such as multiple tickets of the same class level for the same event. Subsequent to receiving the match upgrades, these criteria may be evaluated and altered as desired by the service provider.

For example, bid evaluations may include criteria such as a minimum bid level, where the system may query the database and return only the results which are greater than or equal to the minimum bid amount, or even a dynamic minimum bid level, where the minimum bid level may be calculated dynamically based on individual inventory item amenities, such as length of flight in miles or duration, number of meals on a flight, number of flight attendants servicing, or other amenities.

In another example, bid evaluations may include criteria based on total dollar amount, where the system may query the database and return only results based on bids in order from total dollar amount offered in ascending or descending order.

In another example, bid evaluations may include criteria based on current load factors, where the system may retrieve data representing the current load factor for the total item lot in the database query and determine the number of available matches it should return based on a mathematical calculation.

In another example, bid evaluations may include criteria based on the ability to re-sell lower-tiered inventory held by consumers. In this instance, the system may retrieve data representing the current requests on the lower-tiered inventory, including theoretical items, such as standby requests or waiting lists, to determine the ability of the system to re-sell those items.

In another example, bid evaluations may include criteria based on the loyalty status of consumers, where the system may retrieve data representing the status of the consumer in the system's loyalty program, the provider's loyalty program, or other third party program, if available, and return the results based on a weighted influence of such status. By non-limiting example, an offer from an Air Canada Aeroplan Super Elite member may take priority over a non-Super Elite member, and those results will be returned at the top of the ranking before any others. Alternatively, loyalty status of the consumer may form part of the original bid offer, where the system may retrieve data representing a formulated value of such status to calculate into the returned results. For example, if a Super Elite member's bid is worth $2 for every $1 they bid, a bid of $25 may be calculated as having a value of $50.

In another example, bid evaluations may include criteria based on system or service provider overrides, where the system may subsequently incorporate additional information in the ranking order to override or weight higher, such as weighting a consumer's bid higher when that consumer had previously received an undesirable experience, such as having been bumped off an earlier flight or having missed a connection due to delays, or having lost 5 consecutive bids.

In another exemplary embodiment incorporating the previously described rules sets and evaluations, the system may return matches for less than the total items available, such as returning matches for 12 of 15 seats available on a flight, as calculated based on a current load factor and the number of standby requests for the particular flight. The system may then be instructed to first give priority to Super Elite members, from whom there are 5 bids. However, only 3 of these Super Elite members meet minimum bid level requirements that were set dynamically, such as $0.03 for every mile, where a bid was $20 for a 2,500 mile flight and needed to be a least $75. The system also receives an override for a specific passenger, based on the provider's discretion, who is ranked after the Super Elite members. The final 8 seats (and additionally those seats that are currently made available from the 4 winning bids) are then ranked in order of the selected pricing mechanism, which may be the total dollar amount offered that meets the minimum bid requirements. The ranked list would be as illustrated in Table 1:

TABLE 1

| Consumer | Customer | Loyalty | Bid + | |
|---|---|---|---|---|
| No. | Bid | Status | Multiplier | Override |
| 1 | $125 | Super | $250 | No |
| | | Elite | | |
| | | member | | |
| 2 | $100 | Super | $200 | No |
| | | Elite | | |
| | | member | | |
| 3 | $100 | Super | $200 | No |
| | | Elite | | |
| | | member | | |
| 4 | $75 | None | $75 | Yes |
| 5 | $250 | None | $250 | No |
| 6 | $245 | None | $245 | No |
| 7 | $200 | None | $200 | No |
| 8 | $100 | None | $100 | No |
| 9 | $100 | None | $100 | No |
| 10 | $100 | None | $100 | No |
| 11 | $94 | None | $94 | No |
| 12 | $80 | None | $80 | No |
| 13 | $79 | None | $79 | No |
| 14 | $30 | Super | $60 | No |
| | | Elite | | |
| | | member | | |
| 15-22 | Below | None | Below | No |
| | $75 | | $75 | |

In certain instances, such as when bids may represent more than one customer, the system may segregate and rank submitted bid prices as a function of physical customers or items. In other words, certain bookings may be based on itineraries, and others based on each customer. For example, for a flight, a bid of $75 per person with a two person itinerary, is likely better than a bid of $80 for a single person, and a next highest bid (after the $75 per bid) of $40—that is the total value is $150 for the two person itinerary, and $120 if the other bidders are chosen. Likewise, if for example, certain types of reservations have different characteristics, such as wherein a hotel room would have two members of an itinerary staying in a single room, while the same two customers would need individual seats on an airplane, the rules of the present invention will treat the two types of bids for the two different perishable items differently. That is, a hotel upgrade bid for that itinerary would only lead to one upgrade fee, while an airplane upgrade bid would lead to two fees. For example, if three seats are available on flight, four bids may be submitted as shown in the following Table 2:

TABLE 2

| | | No. Items Bid |
|---|---|---|
| Customer No. | Customer Bid | On |
| 1 | $300 | 1 |
| 2 | $200 | 2 |
| 3 | $150 | 1 |
| 4 | $125 | 1 |

The system may segregate customer #2, who is actually bidding on two items in an itinerary bid, but with only a single fee, instead of bidding on only one seat. By doing so, the winning bids may be Customer #1, #3 and #4 for the 3 seats. It should be appreciated that there may be instances where bids with a lower price per item may ultimately be selected over higher priced bids, such that the sum total of items sold is increased and the revenue generated is greater than a lesser number of items sold at higher prices. As contemplated herein, the system may calculate and/or manipulate any relationship of items available and bids made to reach the greatest revenue possible.

It should be appreciated that by virtue of the customizable, multi-factored rules-based engine, the present invention provides a user and/or operator with tremendous flexibility and consistency not only in revenue maximization across virtually all types of perishable items and providers, but also or alternatively in maximization of customer loyalty, customer satisfaction, or any other measurement of successful business management. In other words, the present invention uniquely provides the user and/or operator the ability to maximize value, where value may be based on any measurement of successful business management as described herein and as would be understood by those skilled in the art.

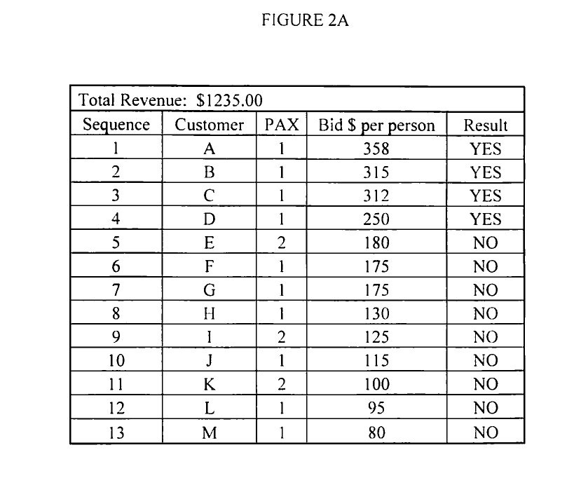

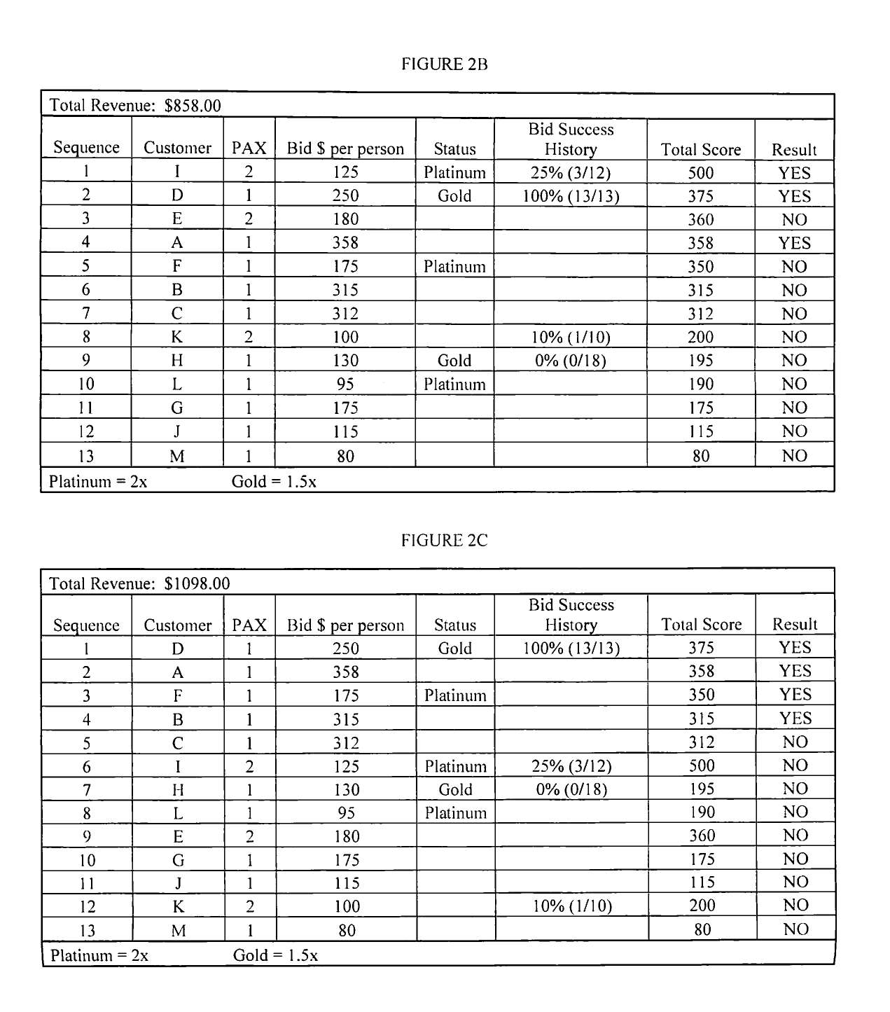

As shown in FIGS. 2B-2C, the present invention includes a customizable and multi-factored platform for determination of value not seen in existing models, as highlighted in FIG. 2A. For example, as seen in FIG. 2A, an existing system provides an operator with a single-factor determinative value model, for selecting 4 customer bids to maximize revenue. Of the 13 sequenced customers, the system identified the bid price as the sole determinative factor of value, and consequently accepted the 4 highest customer bids (Customers A, B, C and D) for a total value of $1,235.00.

However, using the same Sequence of 13 customer bids, the exemplary systems illustrated in FIGS. 2B and 2C demonstrate the more dynamic and multi-factored value model utilized by the present invention. As seen in FIGS. 2B and 2C, additional factors, such as Status, Total Score, Number of persons (PAX), Bid Price (per person), and System History are available, either separately or in any combination, to reach the selection of 4 customer bids to maximize value and/or business success. In FIG. 2B, the operator has customized the rules based engine to reward greatest customer loyalty and customer success History in combination with revenue maximization. Here, the winning bids from the Sequence of 13 customer bids are customers I, D and A (where customer I represents two people). This selection added into the calculation a 2× bid value multiplier for Platinum Status customer, and a 1.5× bid value multiplier for Gold Status customers to calculate a value “Score” for each customer, and likewise preferentially ranked customers with a recent lower success History over those customers with a recent higher success History. Thereby, the present invention as embodied in FIG. 2B overweighted loyalty based business parameters to reward preferred customers for the system operator. Now taking again the same sequence of 13 customer bids as seen in FIGS. 2A and 2B, the exemplary embodiment of FIG. 2C illustrates the present invention's ability to be customized yet again with a more even weighting of maximum bid prices with customer loyalty, where the winning customers are D, A, F and B. Here, higher Status customers are still rewarded, but with greater emphasis on revenue to the system operator when calculating maximum value.

Thus, the present invention may include rules that vary the acceptability of bids from certain people, certain itineraries, or bids meeting certain criteria. For example, the acceptability of bids may vary as the perish time of the perishable item draws nearer. That is, if a bid is allowed one week before the item, and the minimum bid is $100, but a rule dictates that the minimum acceptable bid is $150, then the minimum acceptable bid may fall to $110 the day of the item if inventory remains unfilled. Of course, as such, the present invention may be employed whether inventory is known or unknown. Likewise, as detailed above variations in acceptability may be provided based on actual bid value (such as wherein multiple people are actually on a bid itinerary, such as wherein two people stay in one hotel room, but need two seats on a plane), bid history, status, overrides, or the like, for example.

As mentioned previously, the present invention may include a variety of tie-breaking mechanisms. The system may pre-set these rules and criteria, or may allow them to change them, such as via a control panel, such as the aforementioned GUI, in a dynamic environment. By non-limiting example, tie-breaking mechanisms may include cascading, weighting, or combining of factors to determine a priority in tie-breaking. Any or all tie-breaking criteria may also be set on each individual item, or as a global rules set for related items. All tie-breaking mechanisms may be used individually or in any combination, as desired by the system or service provider.

In one exemplary embodiment, the tie-breaking mechanism may include a time stamp, where the system may query the database and rank all the tied match bids by the earliest time the bid was submitted.

In another exemplary embodiment, the tie-breaking mechanism may include the status of the consumers, where the system may receive data indicative of the status of the consumer(s) in a loyalty/reward program, if available, and award the tie-breaker to the consumer with a higher loyalty status. Alternatively, a consumer using the system most frequently may be used as an identifier in lieu of an official loyalty or rewards program.

In another exemplary embodiment, the tie-breaking mechanism may include tie-breaker insurance, where the system would query the database and identify if the match bid has a tie-breaking insurance paid to insure the bid. Matches with insurance may thus be returned in a higher ranking then matches without.

In another exemplary embodiment, the tie-breaking mechanism may include overrides, where the system may query the database and identify if the bid contains an override in a tie-breaking situation. Matches with the override may be returned in a higher ranking than matches without.

Returning to the earlier embodiment in which the match results were tabled, the system returned ties between customers #2 and #3, and between customers #8, #9 and #10. The order of these ties was established by determining that user #2 submitted their respective bid an hour before user #3, and the same may have applied to customer #9 over customer #10. Customer #8 however, had tie-breaking insurance, and even though customer #8 submitted their bid after customer #9 and #10, the system rules set placed insurance as a priority over time stamps for all tie-breaking mechanisms.

Once the system receives a select number of customer bids, the rules may be applied to the set of data structures indicative of the pending bids using one or more program code modules in order to determine and rank the winners. The rules may be applied using simple logical programming that tests each bid, or if there are inter-related tests, may create a data structure that is an interim result to be further tested using typical computer programming processes for testing the relationship between data in a data structure. When a rule is processed, it may require additional data, such as customer loyalty program point data or more global data, for example. This data is received by the system for execution of the rule, either over a data network, or received more locally by accessing a more local data storage device.

In an embodiment where all bidding is for upgrade items, and customers are not in jeopardy of missing an event, the system may present, at the time the event closes, the ranked winning customer bids in a display to an service provider agent who is managing the event. Alternatively, the system may use customer contact information to either text, email or robo-call the winning customer(s). The customer contact information may be stored in the customer bid data structure of the system as described previously. Additionally, the system may also recover payment information from the data structure, or contact a secure system with appropriate indicia of identity of the customer and request payment.

According to an aspect of the present invention, once it has been determined that a consumer is purchasing a product not of the highest tier, the consumer may be prompted with the choice to make a bid or select from presented bids according to the pricing and bidding rules set as selected by the system and/or service provider. For example, a consumer may access the system via a networked laptop, and prompted through a webpage interface to place a bid for an upgrade of an item. This prompt may be displayed subsequent to the customer's purchase of a lower level item, or as an option prior to completing the transaction of the lower level item. For example, when a consumer buys a ticket to a music concert via a ticket sales website and selects the 2nd best available seating option, the consumer may then be prompted with an option that would entail paying more, but theoretically not as much as what would have been considered “full fare” as originally listed for the upgrade item. If the consumer wishes to participate in this process, their bid would be submitted, and if the bid is determined to be a winner, he would be charged accordingly and given the upgraded item. Of course, the consumer may be made aware of the fact that the bid constitutes a binding offer and requested to acknowledge this fact.

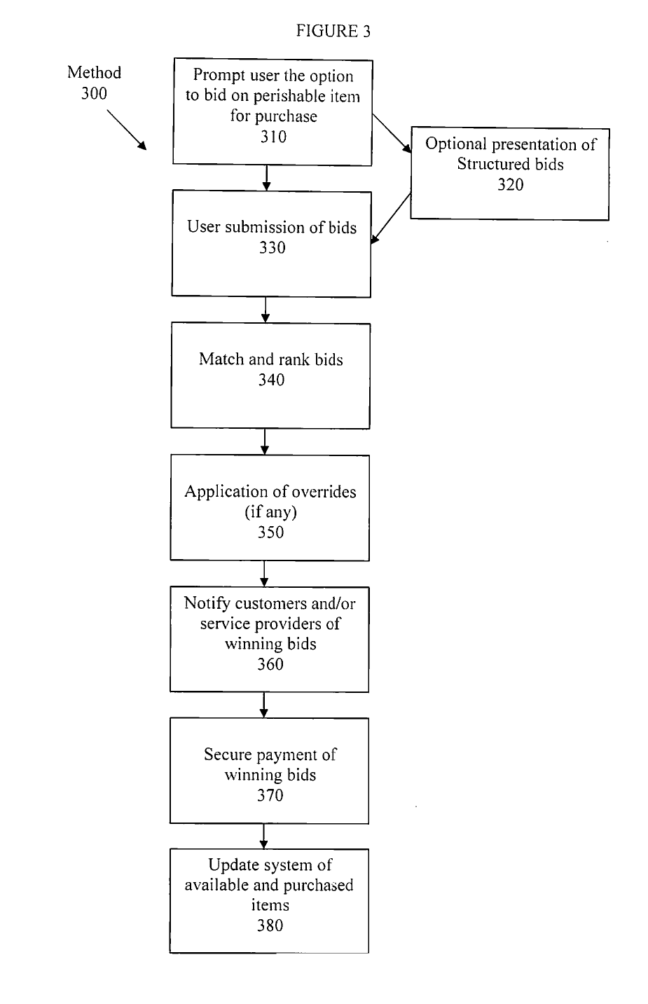

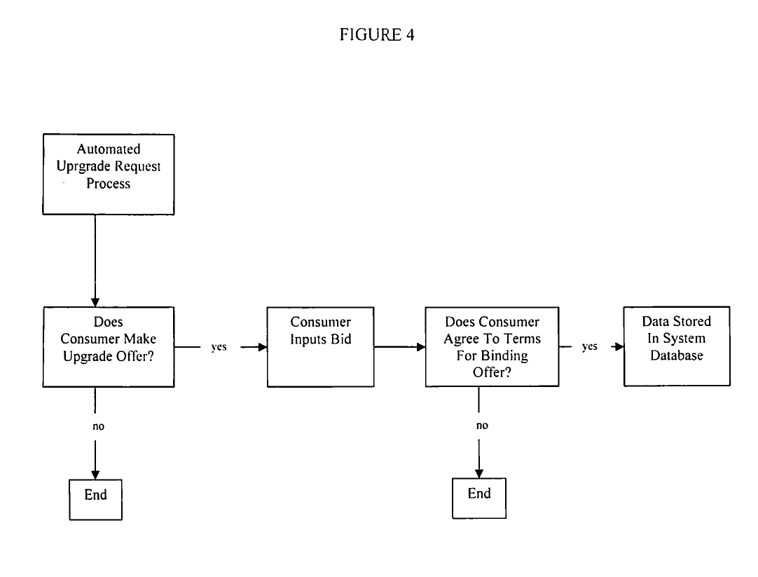

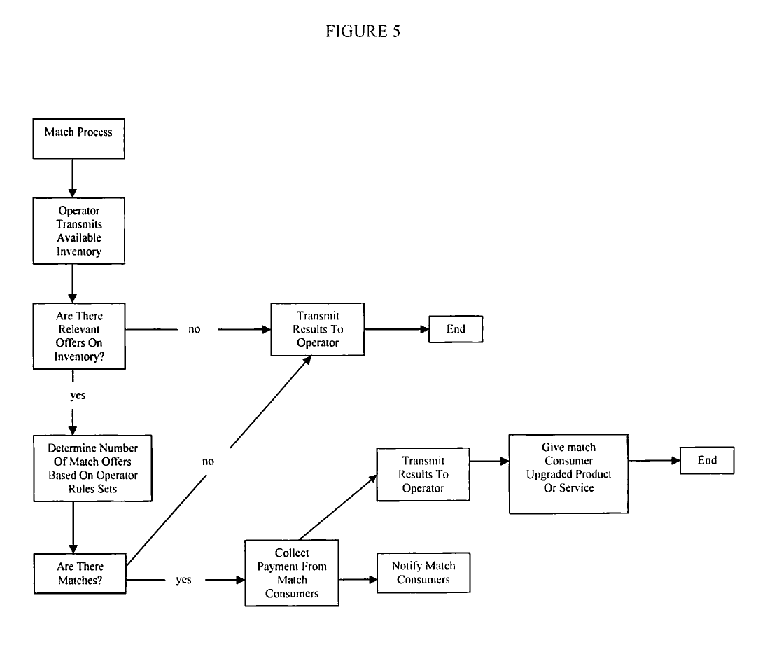

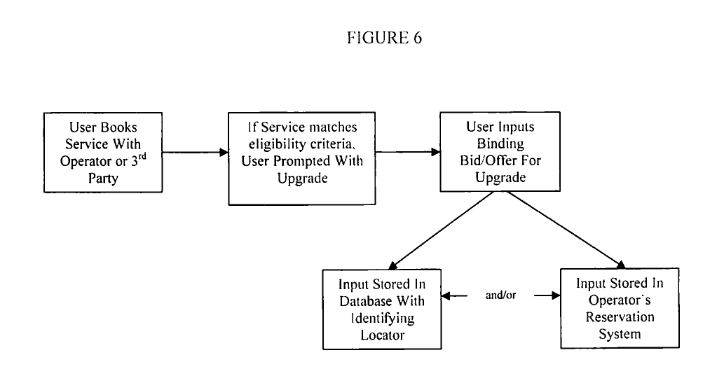

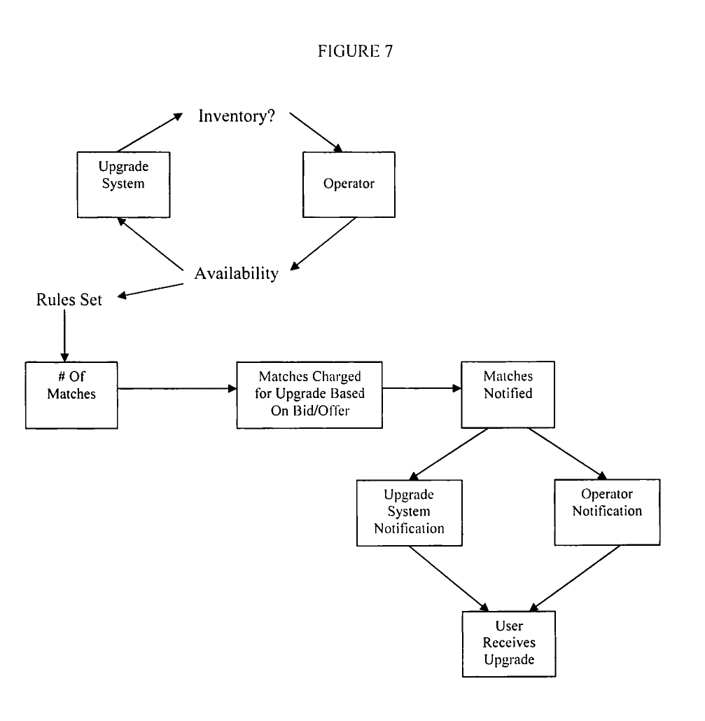

The present invention also provides for a method of increasing revenue from the sale of perishable items via system functionality as described hereinthroughout. For example, as shown in FIG. 3, method 300 may function specifically as an upgrade system for all customers that have either purchased or reserved an item, and where at least one related item of a higher quality or tier are available. At step 310, the system may prompt or present to the customer an option to purchase a higher tier item for the same event for which the originally purchased (lower tier) item relates to. At step 320, the system provider may optionally present structured bids according to a selected rules set. At step 330, customers submit bids to the system provider, either as responsive or selected from the structured bidding parameters presented at step 320, or as open bids, where the customers can freely bid as they choose. At step 340, the system may apply the rules set to match and rank all submitted bids to the items available for purchase. At step 350, the system may apply any overrides or other default parameters to complete the final winning bids list. At step 360, the system may notify all customers that submitted bids as to whether or not they submitted winning bids. At step 370, payment for winning bids is made. At step 380, all results are acknowledged by the service provider, and the pool of available items is refreshed to reflect all movement of customers as between purchased event items. Additional exemplary methods are illustrated in FIGS. 4-7. It goes without saying that the methods of the present invention, as contemplated herein, may functionally include steps corresponding to each and every feature of the aforementioned system as described hereinthroughout. It should also be appreciated that all methods and processes as contemplated herein may apply to any system provider, whether such system provider acts as an independent entity or as part of the original service provider's own platform.

Unlike existing upgrade systems, the present invention uniquely provides both initial item purchasing and upgrade services in a dynamic and seamless fashion, with open ended bidding periods and real time updating of known item availability. By doing so, the present invention is not limited to undesirable time restraints or enrollment periods, or unknown item availability, which inhibit the maximization of revenue for the sale of the total perishable items for a given event. Likewise, the present invention may utilize a number of pricing and bidding mechanisms, such as an open auction model, to allow for the greatest price to be offered by prospective customers. This feature also allows the present invention to be consumer centric, in that the consumer may feel in control of their bidding. Further still, unlike competing upgrade systems, the present invention provides for optional non-monetary pricing and bidding, as well as override mechanisms, to allow greater flexibility to system providers in incorporating reward point systems, charitable donations and loyalty exceptions for unprecedented customer experiences.

Those of ordinary skill in the art will recognize that many modifications and variations of the present invention may be implemented without departing from the spirit or scope of the invention. Thus, it is intended that the present invention cover the modification and variations of this invention provided they come within the scope of the appended claims and their equivalents.

1. A software engine for increasing sales revenue of ones selected from a set of perishable item supplied by at least one service provider, comprising:
at least one computing memory having associated therewith a plurality of rules, wherein at least ones of the plurality of rules comprise:
a first information item relating to a total number of perishable items available for sale in the set;
a second information item relating to a price of at least the available ones of the set;
a bid acceptor for accepting at least two discrete bids on ones of the available ones, wherein each of the discrete bids comprises a unique dollar value, wherein the bid acceptor is locally associated with a networked computing device, and wherein at least the price and the total number constrain acceptable ones of the at least two discrete bids;
at least one networked computer processor that receives the at least two bids over a network from the networked computing device, and that applies ones of the plurality of rules to select the acceptable ones for recommendation to the at least one service provider; and
an output from the at least one networked processor that reports, in accordance with at least one of the applied ones of the plurality of rules, to the at least one service provider the acceptable ones.

2. The engine of claim 1, wherein the at least one perishable item is an upgrade of an item from the set previously reserved by the user.

3. The engine of claim 1, wherein the bids comprises an auction.

4. The engine of claim 1, wherein the bids comprise a timeframe that begins when at least one of the perishable items supplied by the service provider becomes an available one.

5. The engine of claim 1, wherein the first information item is updatable in real time.

6. The engine of claim 1, wherein the second information item is at least a suggested price.

7. The engine of claim 6, wherein the suggested price is a minimum price.

8. The engine of claim 6, wherein the at least one suggested price is a preselected percent value of less than 100% of an original retail price.

9. The engine of claim 6, wherein the at least one suggested price is a preselected price range that is less than an original retail price.

10. The engine of claim 1, wherein at least one of the bids at least partially contains a charitable donation.

11. The engine of claim 1, wherein at least one of the bids at least partially contains a non-monetary component.

12. The engine of claim 11, wherein the non-monetary component corresponds to a specific action performed by the bidding user.

13. The engine of claim 11, wherein the non-monetary component is at least one rewards program point.

14. The engine of claim 1, wherein the plurality of rules further comprises at least one information item selected from the group consisting of length of travel, traditional purchasing patterns of users, current load factor, demand for a lower-tiered item, and a loyalty program status of the user.

15. The engine of claim 1, wherein the list of winning bids is ranked.

16. The engine of claim 15, wherein the list is ranked according to a priority rules set.

17. The engine of claim 1, wherein the perishable item set is at least one selected from the group consisting of airline tickets, train tickets, bus tickets, automobile rentals, cruise tickets, hotel room reservations, house reservations, concert tickets, sporting event tickets, shipping reservations and conference reservations.

18. A method of increasing sales revenue of a perishable item set supplied by at least one service provider, comprising:
sending an invitation to at least one user to bid on at least one available perishable item from the perishable item set, the invitation generating from a networked computer processor and transmitted via a communications network to a networked computing device operated by the at least one user;
applying a plurality of rules resident on at least one computing memory associated with the networked computer processor, wherein at least ones of the plurality of rules comprise:
a first information item relating to a possible number of perishable items available for sale in the perishable item set;
a second information item relating to a price of each of the perishable items available for sale;
wherein the plurality of rules constitute a bidding mechanism for the user to place at least one bid on at least one of the available perishable items;
receiving at least one bid on the at least one available perishable item from the networked computing device operated by the user;
generating a recommended list of winning bids for ones of the available perishable items; and
transmitting to the at least one service provider a report corresponding to the recommended list of winning bids.

19. The method of claim 18, wherein the at least one perishable item is an upgrade of an item from the perishable item set previously reserved for the user.

20. The method of claim 18, wherein the bidding mechanism is an auction.

21. The method of claim 18, wherein the bidding mechanism has a timeframe that begins when at least one of the perishable items supplied by the service provider becomes available for sale.

22. The method of claim 18, wherein the first information item is updatable in real time.

23. The method of claim 18, wherein the second information item is at least one suggested price.

24. The method of claim 23, wherein the suggested price is a minimum price.

25. The method of claim 23, wherein the at least one suggested price is a preselected percent value of less than 100% of an original retail price for the at least one available perishable item.

26. The method of claim 23, wherein the at least one suggested price is a preselected price range that is less than the original retail price for the at least one available perishable item.

27. The method of claim 18, wherein the received bid at least partially contains a charitable donation.

28. The method of claim 18, wherein the received bid at least partially contains a non-monetary component.

29. The method of claim 28, wherein the non-monetary component corresponds to a specific action performed by the bidding user.

30. The method of claim 28, wherein the non-monetary component is at least one rewards program point.

31. The method of claim 18, wherein the plurality of rules further comprises at least one information item selected from the group consisting of length of travel, traditional purchasing patterns of users, current load factor, demand for a lower-tiered item, and a loyalty program status of the user.

32. The method of claim 18, wherein the recommended list of winning bids is ranked.

33. The method of claim 32, wherein the recommended list is ranked according to a priority rules set.

34. The method of claim 18, wherein the perishable item set is at least one selected from the group consisting of airline tickets, train tickets, bus tickets, automobile rentals, cruise tickets, hotel room reservations, house reservations, concert tickets, sporting event tickets, shipping reservations and conference reservations.

35. A system for increasing value for at least one service provider supplying at least one set of perishable items, comprising:
at least one computing memory having associated therewith a plurality of rules, wherein at least ones of the plurality of rules comprise:
a first information item relating to a total number of perishable items available for sale in the set;
a second information item relating to a measurement of value of at least the available ones of the set;
a bid acceptor for accepting at least two discrete bids on ones of the available ones, wherein each of the discrete bids comprises a unique value, wherein the bid acceptor is locally associated with a networked computing device, and wherein the value constrains acceptable ones of the at least two discrete bids;
at least one networked computer processor that receives the at least two bids over a network from the networked computing device, and that applies ones of the plurality of rules to select the acceptable ones for recommendation to the at least one service provider; and
an output from the at least one networked processor that reports, in accordance with at least one of the applied ones of the plurality of rules, to the at least one service provider the acceptable ones.

36. The system of claim 35, wherein the at least one perishable item is an upgrade of an item from the set previously reserved by the user.

37. The system of claim 1, wherein the bid comprises an auction.

38. The system of claim 35, wherein the bid comprises a timeframe that begins when at least one of the perishable items supplied by the service provider becomes an available one.

39. The system of claim 35, wherein the first information item is updatable in real time.

40. The system of claim 35, wherein the second information item comprises a suggested price.

41. The system of claim 40, wherein the suggested price is a minimum price.

42. The system of claim 40, wherein the suggested price is a preselected percent value of less than 100% of an original retail price.

43. The system of claim 40, wherein the suggested price is a preselected price range that is less than an original retail price.

44. The system of claim 35, wherein at least one bid at least partially contains a charitable donation.

45. The system of claim 35, wherein at least one bid at least partially contains a non-monetary component.

46. The system of claim 45, wherein the non-monetary component corresponds to a specific action performed by the bidding user.

47. The system of claim 45, wherein the non-monetary component is at least one rewards program point.

48. The system of claim 35, wherein the plurality of rules further comprises at least one information item selected from the group consisting of length of travel, traditional purchasing patterns of users, current load factor, demand for a lower-tiered item, and a loyalty program status of the user.

49. The system of claim 35, wherein a list of winning bids is ranked.

50. The system of claim 49, wherein the list is ranked according to a priority rules set.

51. The system of claim 35, wherein the perishable item set is at least one selected from the group consisting of airline tickets, train tickets, bus tickets, automobile rentals, cruise tickets, hotel room reservations, house reservations, concert tickets, sporting event tickets, shipping reservations and conference reservations.
